(19) United States
(12) Patent Application Publication
(10) Pub. No.: US 2026/0194382 A1
(43) Pub. Date: Jul. 9, 2026

(54) HVAC Fluid Level Monitoring Device and Warning System

(71) Applicant: Mel Freedman, Lincolnshire, IL (US)

(72) Inventor: Mel Freedman, Lincolnshire, IL (US)

(21) Appl. No.: 19/438,754

(22) Filed: Jan. 2, 2026

Related U.S. Application Data
(60) Provisional application No. 63/742,032, filed on Jan. 6, 2025.

(51) Int. Cl. G01F 23/22; F24F 13/22

(52) U.S. Cl. CPC G01F 23/22; F24F 13/222

(57) ABSTRACT

A fluid level monitoring device, comprising a pipe insert to be arranged within a primary, secondary or auxiliary drain piping of an air conditioning unit, three or more liquid sensor probes arranged on at least one vertical element attached to the pipe insert, a bottom liquid sensor probe located at a distance from the bottom of the pipe insert, a top liquid sensor probe located at the top of the horizontal part of the horizontal pipe segment, and a transmission device connected to said liquid sensor probes, configured to receive status information from each liquid sensor probe, said transmission device configured to sending out a different signal for each liquid sensor probe status or combination thereof.

### BACKGROUND OF THE INVENTION

This disclosure relates generally to electronic condensate overflow switches. More particularly, the present disclosure relates to electronic condensate overflow switches that incorporate means for multiple level detection, use multiple level detection and provide predictive models for detection of a system failure.

Common Heating, ventilating, and air conditioning (HVAC) systems employ evaporator coils to dehumidify and cool the surrounding air. The moisture in the air passing over the evaporator causes condensate to form on the surface of the coils, which builds up and drips off the evaporator coils into a drain pan underneath the coils. The drain pan normally has one or more drain outlets connected to drainpipes that carry away the condensate. This prevents the condensate from overflowing the drain pan and potentially causing damage to attics, ceilings, walls, and the like.

Drain outlets and/or drainpipes can become clogged or otherwise obstructed with dirt, mold, bacteria, fungi, algae, debris, and the like, leading to a rise of the condensate level in the drain pan or in the drainpipe. Condensate overflow switches to detect the rise in the level of condensate, either in the drain pan and/or in the drainpipe are commonly used to shut off power to the HVAC system when the level of condensate rises to a predefined level, avoiding overflow and subsequent damage.

While shutting off the HVAC system may prevent damage to the HVAC system and the surrounding parts of the building due to leaking condensate it can lead to other damage if normal operation is not restored within a short period of time, especially when outside temperatures are very hot and cooling is required for maintaining the structural integrity of the building and/or if maintaining a constant temperature is indispensable for certain equipment and devices within the building to operate normally and not take any harm. Having the system suddenly shut down without notice will also be problematic as it creates a very uncomfortable or even life threatening environment for the homeowner if the outside temperatures and humidity are high.
U.S. Pat. No. 6,442,955 discloses a condensate overflow safety switch that can be attached to an outlet of the drain pan.
U.S. Pat. No. 5,621,393 discloses a filling-level measuring device using a float/magnetic switch to detect a fluid level.
U.S. Pat. No. 7,191,649 discloses a liquid level sensor apparatus to sense the presence of backup liquid in a vertical pipe in the drain system.
U.S. Pat. No. 5,755,105 discloses a sensor apparatus to be connected to the auxiliary drain orifice in the drain pan.
U.S. Pat. No. 5,522,229 discloses a drain tube to be attached to the drain pan with a liquid sensor probe located at least partially in the drain tube.

These inventions have in common, that the main objective is to determine if the level of condensate in the drain pan is to too high or there is a blockage in the drain in order to shut of the system to prevent damage.

It is the object of the present invention to provide a fluid level monitoring device and warning system enabling analysis of the changes of the fluid level in the HVAC drainage system in order to predict a critical problem before it occurs, including a remote warning system allowing automatic information of required preventive maintenance of the HVAC system.

### SUMMARY OF THE INVENTION

In order to be able to monitor the fluid level and providing warnings before a critical status is achieved and the HVAC system is shut off, a pipe insert is arranged within the drain piping of the HVAC drainage system containing three or more liquid level sensors arranged on a vertical element within the pipe insert. With increasing liquid level in the drain pipe an increasing number of the liquid level sensors from the bottom to the top will indicate the presence of liquid allowing a time prediction when the liquid level of the drain pipe will be at the top, which will eventually lead to a system shut off.

A transmission device connected to the liquid level sensors can send out signals depending on the status of individual or a combination of the sensors. The signals transmitted can be sent to a receiving unit, which can collect information from several fluid level monitoring devices.

Using a processor and a database for storing historical values, located either in the transmission device of the receiving unit, a process can be executed to compare and analyze the status values of the liquid level sensors to predict the time the liquid level reaches a critical level and/or the time when the system will automatically shut off and send a corresponding information or data to a mobile application and or a service company.

An advantage of the system is the prevention of the automatic system shut off, by sending a warning or a service request before a critical status of the HVAC system is reached, allowing maintenance to be performed before problems and corresponding potential damages occur.

### BRIEF DESCRIPTION OF DRAWINGS

FIG. 1. Cross Section of a pipe insert with 4 vertically arranged liquid level sensors

FIG. 2. A T-shaped pipe insert with a vertical element with three liquid level sensors

FIG. 3. The closure for the T-shaped pipe insert with a vertical ladder with liquid level sensors

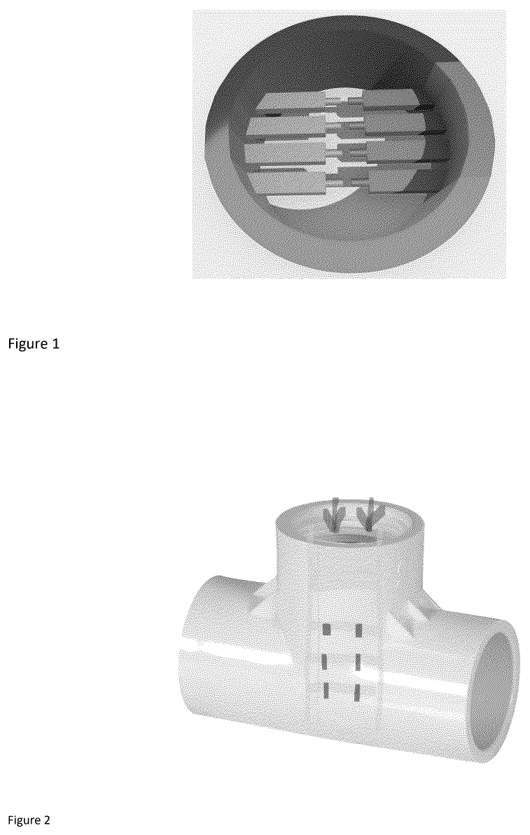

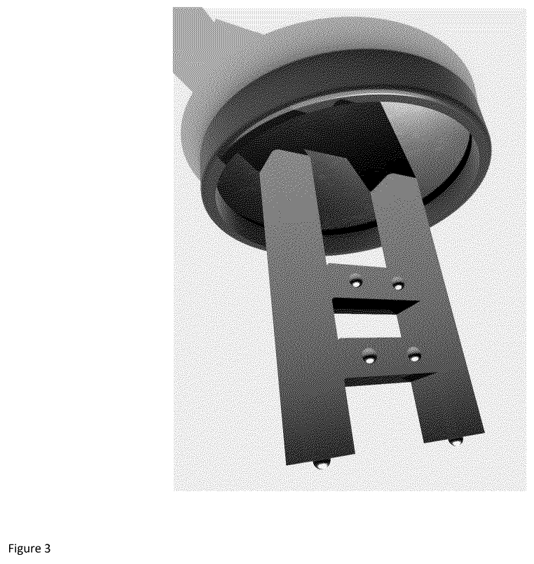

### DETAILED DESCRIPTION OF THE INVENTION

In a first embodiment of the fluid level monitoring devices a pipe insert is arranged within the primary, secondary or auxiliary drain piping of an air conditioning unit. Preferably it is arranged within the primary drain pipe to enable measurements of the fluid level of the condensate before the HVAC system encounters any issues, which would be the case if it was arranged only in the secondary or auxiliary drain pipe. To allow multiple measurements, additional fluid level monitoring devices can be arranged within the secondary and/or auxiliary drain piping, or additional devices can be placed in the piping system at different locations.

Each device has three or more liquid sensor probes arranged on at least one vertical element attached to the pipe insert. If the bottom liquid sensor probe was located at the bottom of the pipe insert it would provide a positive reading indicating the liquid is present anytime liquid passes through the pipe, even in normal operation. To prevent unnecessary cost the bottom liquid sensor probe is placed at a distance from the bottom of the pipe insert. The top liquid sensor probe is ideally located at or very close to the top of the horizontal part of the horizontal pipe segment in a manner that a positive reading of this probe indicates that the piping is completely filled with liquid.

In certain embodiments there are more than three liquid sensor probes located at the same fixed vertical distance from the previous probe or at distances, so that the liquid level at each probe represents a factor of the amount of liquid compared to the bottom probe. Due to the increasing width of the pipe the distance between the probes below the central line of the pipe would decrease and increase again above the center line in such a way that each next higher probe indicates the amount of liquid in the pipe being 2×, 3×, etc. the amount at the bottom liquid sensor probe.

A transmission device is connected to said liquid sensor probes, which is configured to receive status information from each liquid sensor probe, and can send out a different signal for each liquid sensor probe status, being positive (liquid present) or negative (no liquid present). In an alternative embodiment different signals could be sent out depending on each combination of status information from the probes, essentially indicating the liquid level in the pipe.

In a preferred embodiment the pipe insert is T-shaped, with the vertical part of the pipe segment facing upward. The vertical part has an opening at the top through which the piping can be cleaned and the vertical element with the liquid sensor probes can be inserted down into the horizontal section of the piping. This vertical part of the pipe segment is attached to a closure fitted to the top of the vertical part of the T-shaped insert. The closure and the vertical element of the pipe segment can be removable.

The vertical element can consist of a ladder, where one liquid sensor probe is arranged on each rung of the ladder. This arrangement has the advantage that it minimizes the blockage of the pipe, as the liquid can flow through the ladder.

In a further embodiment the liquid sensor probes consist of electrodes, which may include an anode and a cathode that are able to conduct electricity there between in the presence of a fluid medium. Any other type of liquid sensor probe can also be used including electrical, magnetic, sonar or optical sensors or a combination of different types of sensors can be arranged on the vertical element.

To allow calculation of the expected fluid level in the piping and predicting the point in time when the pipe is completely filled with liquid a memory is configured to store several datasets as well as one or more processes. A processor stores the current status information of the liquid sensor probes as a current dataset in the memory and reads one or more previously stored datasets, in order to analyze and compare these datasets with the current dataset according to one of the stored processes. One stored process allows the calculation of a point in time, when the liquid level will reach the top liquid sensor probe, another process calculates the speed of the rising fluid level, or other values useful to allow an assessment of the necessity for maintenance or other actions to prevent a shut down of the HVAC cooling system.

The memory and the processor can be integrated in the transmission device and send out a signal containing the current status of the liquid sensor probes and the calculated prediction time to any receiving device, such as a mobile phone or the information could be stored in the cloud.

In a preferred embodiment one or more fluid level monitoring devices are included in a fluid level warning system and the transmission device(s) send the signals to a receiving unit, which includes the memory and the processor, which store the datasets and execute the stored processes. The receiving unit then communicates the current status of the liquid sensor probes and calculated values to a mobile application.

In order to prevent loss of time if the prediction of the shut off time is close and/or if the liquid level is rising very fast the communication can also be sent directly to a pre-defined service company requesting a service visit as soon as possible.

Depending on the configuration of the HVAC system the installer of the fluid level monitoring device or the fluid level warning system can select the processes to be executed by the processor and or the processes or some key values of the system can be configured manually to best match the present HVAC system and the piping configuration.

In a preferred embodiment the processor uses self-learning methods to adjust and improve the prediction model using previous shutdown events of the system and or shut downs artificially induced by a service technician, when installing the system.

### Cloud Integration

In another embodiment the receiving unit is a gateway device and the functions of the memory and processor are moved to a cloud infrastructure. The cloud infrastructure supporting the HVAC fluid monitoring system is designed for scalability, reliability, and secure data processing. Platforms such as Amazon Web Services (AWS), Microsoft Azure, or Google Cloud provide the foundation for this infrastructure, leveraging their robust ecosystems of services and tools.

### Data Transmission

Each sensor transmits real-time data wirelessly via protocols like Wi-Fi, Bluetooth, or Zigbee to a gateway device, which aggregates and forwards the data to the cloud. This transmission is secured using encryption protocols such as TLS or SSL to ensure data integrity and prevent unauthorized access during transit.

### Cloud Services

Upon reaching the cloud, the data is ingested through services tailored for real-time streaming or messaging, such as AWS IoT Core, Azure IoT Hub, or Google Cloud IoT Core. These services act as entry points, authenticating devices and ensuring secure data transfer into the cloud environment.

### Data Storage

In the cloud, the transmitted data is stored in databases optimized for real-time and historical data analysis. Examples include:
AWS DynamoDB: A highly scalable NoSQL database designed for low-latency operations.
Azure Cosmos DB: A globally distributed database supporting multiple data models.
Google Cloud Firestore: A NoSQL database for live synchronization of structured data.

Historical data is typically archived in cost-effective storage solutions like AWS S3, Azure Blob Storage, or Google Cloud Storage, ensuring long-term availability for analytical purposes.

### Data Processing and Analytics

The cloud's processing layer employs scalable compute services to analyze incoming data and generate actionable insights. For instance:
AWS Lambda: Runs serverless functions triggered by data changes, performing real-time computations.
Azure Functions: Executes lightweight serverless processing tasks based on defined triggers.
Google Cloud Functions: Enables event-driven processing for rapid response to data changes.

Machine learning models, deployed on platforms such as AWS SageMaker, Azure Machine Learning, or Google Cloud AI Platform, analyze the fluid levels'trends, predict critical thresholds, and calculate the time to potential overflow. These models are continuously updated using historical datasets to improve prediction accuracy.

### Notifications and Integrations

Once the calculations are complete, the cloud sends notifications to users and service providers. This is achieved through:
AWS Simple Notification Service (SNS), Azure Notification Hubs, or Google Firebase Cloud Messaging (FCM) for push notifications and alerts.
RESTful APIs hosted on services like AWS API Gateway, Azure API Management, or Google Cloud Endpoints, enabling integration with third-party HVAC service platforms.

### Security and Monitoring

The system incorporates cloud-native tools for security and operational monitoring:
AWS CloudWatch, Azure Monitor, or Google Cloud Operations Suite track performance and identify issues in real time.
Role-based access control (RBAC) and multi-factor authentication (MFA) are enforced through services like AWS IAM, Azure Active Directory, or Google Identity and Access Management.

### Scalability and Reliability

The use of autoscaling groups and container orchestration platforms, such as Kubernetes (managed by AWS EKS, Azure AKS, or Google GKE), ensures the system can handle increasing data loads and adapt to growing deployments without manual intervention. Redundancy and multi-region configurations minimize downtime and enhance system reliability.

By leveraging these advanced cloud capabilities, the HVAC fluid monitoring system ensures secure, efficient, and scalable processing of sensor data, enabling predictive maintenance and timely notifications to users and service providers.

1. A fluid level monitoring device, comprising:
a pipe insert to be arranged within a primary, secondary or auxiliary drain piping of an air conditioning unit,
three or more liquid sensor probes arranged on at least one vertical element attached to the horizontal pipe insert,
a bottom liquid sensor probe located at a distance from a bottom of the pipe insert,
a top liquid sensor probe located at a top of the horizontal pipe segment, and a transmission device connected to the liquid sensor probes, configured to receive status information from each liquid sensor probe,
the transmission device configured to sending out a different signal for each liquid sensor probe status or combination thereof.

2. The fluid level monitoring device according to claim 1,
wherein the pipe insert is T-shaped, with a vertical part of the T-shaped pipe segment facing upward,
a closure fitted to a top of the vertical part of the pipe segment, and the vertical element attached to the closure.

3. The fluid level monitoring device according to claim 1,
wherein the closure and the vertical element are removable.

4. The fluid level monitoring device according to claim 2,
wherein the vertical element consists of a ladder and one liquid sensor probe is arranged on each rung of the ladder.

5. The fluid level monitoring device according to claim 3,
wherein the liquid sensor probes consist of electrodes, which may include an anode and a cathode that are able to conduct electricity therebetween in the presence of a fluid medium.

6. The fluid level monitoring device according to claim 1,
wherein different types of liquid sensor probes are used in combination.

7. The fluid level monitoring device according to claim 1,
the transmission device further comprising:
a memory configured to store several datasets and one or more processes that, when executed by a processor, are operable to:
store a current status information of the liquid sensor probes as a current dataset in the memory,
read one or more previously stored datasets and analyze and compare these datasets with the current dataset,
calculate a prediction time, when a liquid level will reach the top liquid sensor probe according to a stored process,
wherein the transmission device sends out a signal containing the current status of the liquid sensor probes and the calculated prediction time.

8. A fluid level warning system comprising at least one fluid level monitoring device according to claim 1, further comprising:
at least one receiving unit for receiving the signals sent by each transmission device,
a mobile application or a cloud service configured to communicate with the receiving unit,
the receiving unit further comprising:
a memory configured to store several datasets and one or more processes that, when executed by a processor, are operable to:
store the current status information of the liquid sensor probes as a current dataset in the memory,
read one or more previously stored datasets and analyze and compare these datasets with the current dataset,
calculate a prediction of when the liquid level will reach the top liquid sensor probe according to a stored process,
wherein the receiving unit communicates the current status of the liquid sensor probes and the calculated prediction value to the mobile application or cloud service.

9. The fluid level warning system according to claim 5,
wherein the receiving unit or the mobile application additionally communicates with a pre-defined service company requesting a service visit before the prediction time.
